(19) United States
(12) Patent Application Publication
(10) Pub. No.: US 2012/0268927 A1
(43) Pub. Date: Oct. 25, 2012

(54) LIGHTING DEVICE

(75) Inventors: Takashi SAITO, Osaka (JP); Ayako Tsukitani, Kyoto (JP); Hiroki Noguchi, Hyogo (JP); Naohiro Toda, Osaka (JP); Sayaka Yamaguchi, Kyoto (JP)

(73) Assignee: Panasonic Corporation, Osaka (JP)

(21) Appl. No.: 13/449,624

(22) Filed: Apr. 18, 2012

(30) Foreign Application Priority Data
Apr. 21, 2011 (JP) 2011-094841

(51) Int. Cl. F21S 4/00

(52) U.S. Cl. 362/227

(57) ABSTRACT

A lighting device includes a lower irradiation portion for irradiating light mainly in a vertically downward direction and an upper irradiation portion for irradiating light more horizontally than the lower irradiation portion. An irradiation angle of the upper irradiation portion is smaller than that of the lower irradiation portion. The upper irradiation portion is configured to reduce an S/P ratio denoting a ratio of scotopic vision luminance to photopic vision luminance.

### FIELD OF THE INVENTION

The present invention relates to a lighting device mainly used in a mesopic vision environment.

### BACKGROUND OF THE INVENTION

In a variety of lighting devices such as a fluorescent lamp and a light emitting diode (LED element), it is typical that a design for increasing the photopic vision luminance is carried out in a bright (photopic vision) environment. This is to enable a brightness-perceiving cone to work under a photopic vision condition. By increasing the photopic vision luminance, it is possible for humans to perceive brightness in a reliable manner.

Under a so-called mesopic vision environment as available in a street space or a road space at night, a rod having a spectral luminous efficiency peak value of 507 nm and capable of perceiving brightness in a photopic vision condition works in addition to the cone having a spectral luminous efficiency peak value of 555 nm. For that reason, it is less effective to merely increase the photopic vision luminance.

In a lighting device disclosed in, e.g., Japanese Patent Application Publication No. 2008-203385, it is attempted to enhance the visibility of a peripheral visual field under a mesopic vision environment by increasing a S/P ratio of an irradiation unit (light source unit) for irradiating light. The S/P ratio refers to the ratio (Ls/Lp) of the scotopic vision luminance Ls which is calculated by adding the lamp spectral characteristic to the spectral luminous efficiency V (λ) under a scotopic vision condition, to the photopic vision luminance Lp which is calculated by adding the lamp spectral characteristic to the spectral luminous efficiency V (λ) under a photopic vision condition.

In the lighting device cited above, however, short-wavelength components contained in the irradiated light grow larger due to the increase in the S/P ratio of irradiation unit (light source unit). As a consequence, it becomes easy for humans to feel dazzling. It is therefore likely that the light of the lighting device may be felt unpleasant when the lighting device exists within the view field of humans.

### SUMMARY OF THE INVENTION

In view of the above, the present invention provides a lighting device capable of alleviating glare under a mesopic vision environment and eventually reducing unpleasantness.

In accordance with an embodiment of the present invention, there is provided a lighting device, including: a lower irradiation portion for irradiating light mainly in a vertically downward direction; and an upper irradiation portion for irradiating light more horizontally than the lower irradiation portion, an irradiation angle of the upper irradiation portion being smaller than that of the lower irradiation portion, the upper irradiation portion being configured to reduce an S/P ratio denoting a ratio of scotopic vision luminance to photopic vision luminance.

Further, the upper irradiation portion may be configured such that the light irradiated from the upper irradiation portion becomes smaller in luminance than the light irradiated from the lower irradiation portion.

Further, the irradiation angle of the upper irradiation portion may be 25 to 35 degrees with respect to a horizontal direction.

Further, the lower irradiation portion may have an irradiation range from 30 to 90 degrees with respect to a horizontal direction and the upper irradiation portion may have an irradiation range from 0 to 30 degrees with respect to the horizontal direction.

The device may further include a lower light source unit corresponding to the lower irradiation portion; and an upper light source unit corresponding to the upper irradiation portion.

With such configuration, it is possible to provide a lighting device capable of alleviating glare under a mesopic vision environment.

### BRIEF DESCRIPTION OF THE DRAWINGS

The objects and features of the present invention will become apparent from the following description of embodiments, given in conjunction with the accompanying drawings, in which:

FIG. 1A is a schematic configuration view showing a lighting device according to one embodiment of the present embodiment and FIG. 1B is a section view thereof;

FIG. 2 is a characteristic diagram for explaining a filter portion employed in a globe of the lighting device;

FIGS. 3A and 3B are section views illustrating another example of the lighting device;

FIG. 4 is a section view illustrating a further example of the lighting device; and

FIG. 5 is a section view illustrating a still further example of the lighting device.

### DETAILED DESCRIPTION OF THE PREFERRED EMBODIMENTS

One preferred embodiment of the present invention will now be described with reference to the accompanying drawings which form a part hereof.

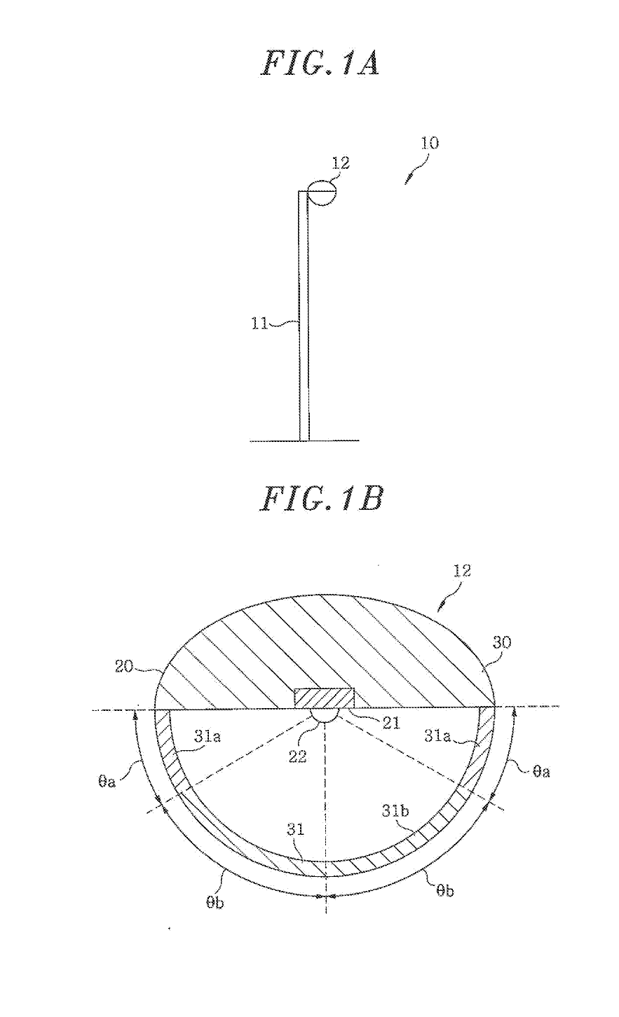

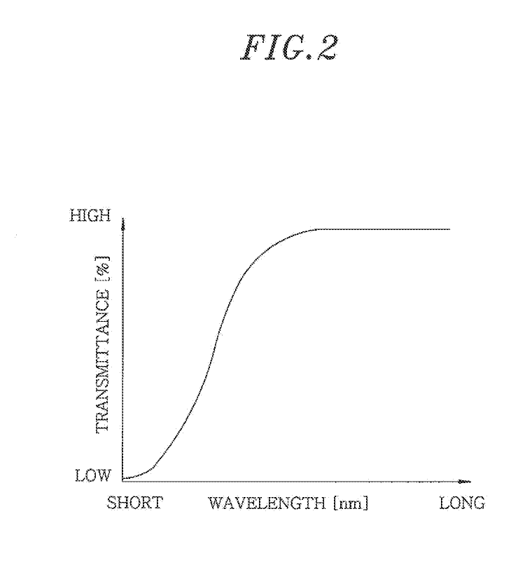

Referring to FIGS. 1A and 1E, the lighting device 10 of the present embodiment includes a cylindrical columnar pole 11 and a device body 12 attached to the tip end of the pole 11.

The pole 11 is used for holding, e.g., a load lamp or a street lamp, and is configured to have such a height that the device body 12 can be installed higher than the stature of a human. The device body 12 includes a housing 20, a lighting circuit 21 provided within the housing 20 and a light emitting unit 22 formed of LED elements to be turned on and off by the lighting circuit 21.

The housing 20 includes a substantially hemispherical housing body 30 to be fixed to the pole 11 by screws or the like and a substantially hemispherical globe 31 attached to the housing body 30. The housing body 30 is formed into a hemispherical shape so that, when the housing body 30 is installed on the pole 11, the upper portion thereof has a semicircular shape and the lower portion thereof has a substantially planar shape. For example, the lighting circuit 21 and the light emitting unit 22 are provided on the lower surface of the housing body 30.

The globe 31 is attached to the lower portion of the housing body 30 and is made of a transparent light-transmitting material such as a acryl resin or a glass. The globe 31 includes a first globe portion 31a attached to the housing body 30 and a second globe portion 31b continuously extending from the first globe portion 31a. The first and second globe portions 31a and 31b are one-piece formed with each other.

The first globe portion 31a is configured to irradiate the light emitted from the light emitting unit 22 more horizontally (vertically upward) than the light irradiated by the second globe portion 31b and to have a narrow irradiation angle with respect to the horizontal direction. More specifically, as shown in FIG. 1B, the first globe portion 31a is configured such that the irradiation angle θa thereof can be about 30 degrees with respect to the horizontal direction. Accordingly, the irradiation extent ranges from 0 (the horizontal direction) to 30 degrees and from 150 to 180 degrees. In other words, the first globe portion 31a performs irradiation over an angular extent of about 60 degrees.

The first globe portion 31a includes a filter portion (not shown) having such a characteristic that the transmittance of short-wavelength light is smaller than the transmittance of long-wavelength light. Therefore, the first globe portion 31a relatively horizontally irradiating the light emitted from the light emitting unit 22 can make the S/P ratio of the light irradiated by itself smaller than the S/P ratio of the light irradiated from the second globe portion 31b which is made of the same material as that of the first globe portion 31a.

On the other hand, the second globe portion 31b is configured to irradiate the light emitted from the light emitting unit 22 mainly in the vertically downward direction. More specifically, the second globe portion 31b is configured such that the irradiation angle θb with respect to the vertical direction becomes about 60 degrees. In this case, the irradiation angle θb includes an angle of 90 degrees (the vertical direction) with respect to the horizontal direction and ranges from 30 degrees to 90 degrees with respect to the horizontal direction. Therefore, the second globe portion 31b performs irradiation over an angular extent of about 120 degrees which is the sum of an angular extent from 30 to 90 degrees and an angular extent from 150 to 90 degrees with respect to the horizontal direction.

Next, description will be made on the operation of the present embodiment.

In the lighting device 10 of the present embodiment shown in FIGS. 1A and 13, the light emitting unit 22 electrically connected to the lighting circuit 21 is supplied with electric power from a power supply (not shown) and is turned on or off by the lighting circuit 21. The light emitted from the light emitting unit 22 is irradiated toward the outside through the first and second globe portions 31a and 31b making up the housing 20. At this time, the short-wavelength components of the light passing through the first globe portion 31a are reduced by the filter portion provided in the first globe portion 31a. This makes it possible to reduce the S/P ratio.

Next, specific effects provided by the present embodiment will be described.

(1) In the present embodiment, the lighting device includes a second globe portion 31b for irradiating light mainly in a vertically downward direction and a first globe portion 31a for irradiating light more horizontally than the second globe portion 31b, the first globe portion 31a being smaller in irradiation angle than the second globe portion 31b, the first globe portion 31a configured to lower an S/P ratio denoting a ratio of scotopic vision luminance to photopic vision luminance. With this configuration, it is possible to reduce the S/P ratio of the light irradiated in the horizontal direction, thereby alleviating glare. As a consequence, if the lighting device 10 is used as, e.g., a road lamp, it is possible to improve the visual environment even when the lighting device 10 falls within the view field of a driver existing in a relatively distant position. Thanks to the reduced S/P ratio, it is possible to prevent the light irradiated from the lighting device 10 into the neighboring houses from disturbing sleep of a human existing in an indoor space.

(2) In the present embodiment, a filter is provided in the first globe portion 31a. The first globe portion 31a is configured such that the light irradiated from the first globe portion 31a becomes smaller in luminance than the light irradiated from the second globe portion 31b. By reducing the luminance in this manner, it is possible to suppress disability glare and to enhance visibility.

(3) In the present embodiment, the first globe portion 31a is configured to have an irradiation angle of 30 degrees with respect to a horizontal direction. More specifically, the second globe portion 31b has an irradiation angle of from 30 to 90 degrees with respect to the horizontal direction and the first globe portion 31a has an irradiation angle of from 0 to 30 degrees with respect to the horizontal direction. With this configuration, it is possible to alleviate glare in an angular extent of about 30 degrees with respect to the horizontal direction, which is likely to fall within the view field of a driver who drives a motor vehicle.

The embodiment of the present invention may be modified as follows.

In the embodiment described above, the first globe portion 31a making up an upper irradiation portion is configured to have an irradiation angle of about 30 degrees with respect to a horizontal direction. However, the present invention is not limited thereto. The irradiation angle of the first globe portion 31a may be appropriately changed within a range of from about 25 to about 35 degrees. With this configuration, it is possible to cope with the recent diversification in the design of a motor vehicle.

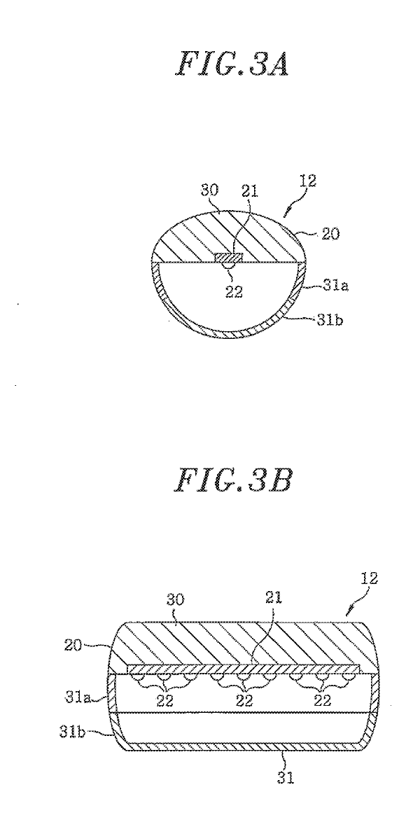

In the embodiment described above, the lighting device is provided with only one light source unit (light emitting unit 22). Alternatively, as shown in FIG. 3B, it may be possible to employ a configuration in which the lighting device includes a plurality of light source units (light emitting units 22). Additionally, as shown in FIG. 3A, it may be possible to employ a configuration in which the light source units (light emitting units 22) are arranged along a single line so that they can overlap with one another when seen in one direction. Needless to say, it may be possible to employ a configuration in which the light source units (light emitting units 22) are arranged in two-dimensional directions.

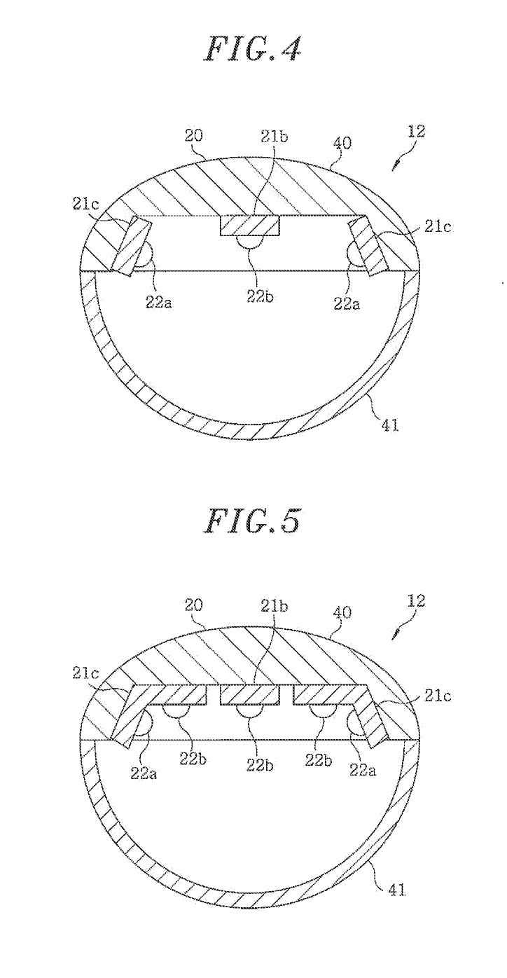

In case of providing a plurality of light source units, as shown in FIGS. 4 and 5, a globe portion 41 may not be provided with a filter portion but may be formed into a uniform shape. In this case, it may be possible to employ a configuration in which the lighting device includes a plurality of upper light emitting units 22a as upper light source units and a lower light emitting unit 22b as a lower light source unit.

As shown in FIG. 4, the lower light emitting unit 22b is formed of a single light source and is electrically connected to a lighting circuit 21b for turning on or off the lower light emitting unit 22b. The lower light emitting unit 22b is oriented such that it can perform irradiation mainly in the vertically downward direction. The upper light emitting units 22a are formed of a plurality of light sources and are electrically connected to lighting circuits 21a for turning on or off the upper light emitting units 22a. The upper light emitting units 22a are oriented such that they can perform irradiation more horizontally than the lower light emitting unit 22b. In this regard, the upper light emitting units 22a employ light sources exhibiting an S/P ratio lower than that of the light source employed in the lower light emitting unit 22b.

In this configuration, a plurality of light emitting units 22a and 22b is installed as the upper and lower irradiation units. This eliminates the need to provide a filter in a specific region of the globe 31 (in the first globe portion 31a in the embodiment described above). While only one lower light emitting unit 22b is provided in the afore-mentioned configuration, it may be possible to employ a configuration in which the lighting device includes a plurality of lower light emitting units 22b (light source units) as shown in FIG. 5. In this case, the light emitting units 22a and 22b making up the upper and lower irradiation units may be provided on, e.g., one lighting circuit 21c.

While no detailed description is made on the filter portion in the embodiment described above, the filter portion may be configured to sharply reduce the light components having a wavelength of 500 nm or less or may be configured to reduce the light components having a wavelength of 555 nm or less, which heavily affects the luminance or the illuminance.

While LED elements are employed as the light emitting units 22 (light source units) in the embodiment described above, the present invention is not limited thereto. Alternatively, the light emitting units 22 (light source units) may be formed of other light sources such as fluorescent lamps and organic EL (electroluminescence) elements.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A lighting device, comprising:
a lower irradiation portion for irradiating light mainly in a vertically downward direction; and
an upper irradiation portion for irradiating light more horizontally than the lower irradiation portion, an irradiation angle of the upper irradiation portion being smaller than that of the lower irradiation portion, the upper irradiation portion being configured to reduce an S/P ratio denoting a ratio of scotopic vision luminance to photopic vision luminance.

2. The device of claim 1, wherein the upper irradiation portion is configured such that the light irradiated from the upper irradiation portion becomes smaller in luminance than the light irradiated from the lower irradiation portion.

3. The device of claim 1, wherein the irradiation angle of the upper irradiation portion is 25 to 35 degrees with respect to a horizontal direction.

4. The device of claim 1, wherein the lower irradiation portion has an irradiation range from 30 to 90 degrees with respect to the horizontal direction and the upper irradiation portion has an irradiation range from 0 to 30 degrees with respect to the horizontal direction.

5. The device of claim 4, further comprising:
a lower light source unit corresponding to the lower irradiation portion; and
an upper light source unit corresponding to the upper irradiation portion.
